(19) United States
(12) Patent Application Publication
(10) Pub. No.: US 2014/0184674 A1
(43) Pub. Date: Jul. 3, 2014

(54) PRINTER AND IMAGING MATERIAL DETECTING DEVICE THEREOF

(71) Applicant: CAL-COMP ELECTRONICS & COMMUNICATIONS COMPANY LIMITED, New Taipei City (TW)

(72) Inventor: Yuan-Ping Yu, New Taipei City (TW)

(73) Assignee: Cal-Comp Electronics & Communications Company Limited, New Taipei City (TW)

(21) Appl. No.: 13/762,367

(22) Filed: Feb. 8, 2013

(30) Foreign Application Priority Data
Dec. 27, 2012 (TW) 101150624

(51) Int. Cl. B41J 2/125

(52) U.S. Cl. CPC B41J 2/125
USPC 347/7

(57) ABSTRACT

A printer includes a container, a detecting unit and a management unit. The container is used for accommodating an imaging material, where the imaging material is a liquid material or a powdery material. The detecting unit is disposed on a surface of the container. The management unit is coupled to the detecting unit. The detecting unit detects a capacitance value to determine a remaining capacity of the container. When the remaining capacity is higher or lower than a threshold, the detecting unit transmits a trigger signal to the management unit. When the management unit receives the trigger signal, the management unit generates a notification.

### CROSS-REFERENCE TO RELATED APPLICATION

This application claims the priority benefit of Taiwan application serial no. 101150624, filed on Dec. 27, 2012. The entirety of the above-mentioned patent application is hereby incorporated by reference herein and made a part of this specification.

### BACKGROUND OF THE INVENTION

1. Field of the Invention

The present invention generally relates to a printer, in particular, to a printer and a detecting device thereof.

2. Description of Related Art

Generally speaking, a laser printer operates substantially as follows. First, a charge tube is used to enable an organic photo conductor (OPC) to be covered with charges, for example, negative charges. Next, a laser light irradiates the OPC according to a pattern to be printed, so that charges at irradiated areas are neutralized. After that, toner carrying negative charges is attached to the OPC through a developer roller, the toner is then attached to the irradiated areas, and the toner cannot attach to areas without being irradiated and still carrying the negative charges because negative charges repel each other. Then, the toner attached to the OPC is transferred to a paper, and the toner is fixed to the paper through fixing by a heating module. Therefore, the printing is accomplished.

As for a color laser printer, the above action is repeated four times, toner of four colors, including C, M, Y, and K, is attached to the OPC and transferred to the paper. In addition, there is also a method of first transferring toner of different colors to a belt, and transferring together to the paper. However, no matter which method is used, a carrier to which the toner attaches, for example, an OPC or a belt, must be cleaned after the transferring. That is to say, during fixing, residual toner on the OPC or belt is removed by using a rubber scraper, and the residual toner is collected to a waste toner cartridge. Therefore, when the waste toner cartridge is filled with the residual toner but is not detected, printer fault may be caused, so that the printer cannot work normally.

In order to detect the current capacity of the waste toner cartridge, a detecting unit may be disposed near an opening of the waste toner cartridge. The detecting unit in the prior art includes a light emitter and a light detector that are correspondingly disposed near the opening. When the light detector cannot detect the light emitted by the light emitter, it is learned that the light emitted by the light emitter has been blocked by the residual toner, and a signal is converted to indicate that the waste toner cartridge is full. However, this method may have some uncertainty; for example, when the residual toner is attached to a place near the light detector or the light emitter, it easily occurs that the above detection is inaccurate.

### SUMMARY OF THE INVENTION

Accordingly, the present invention is directed to a detecting device and a printer using the detecting device, which are capable of detecting a remaining capacity in a container, for example, a remaining capacity of a toner cartridge ink cartridge or a waste toner cartridge, in a non-contact mode.

The present invention provides a detecting device, which is adapted to be disposed in a printer, and includes a container and a detecting unit. The container is used for accommodating an imaging material, where the imaging material is a powdery material or a liquid material. The detecting unit is disposed on an outer or inner surface of the container, and is used for detecting a capacitance value of the imaging material to determine a remaining capacity of the container, when the remaining capacity is lower or higher than a threshold, the detecting unit transmits a trigger signal to a management unit of the printer to generate a notification.

The present invention provides a printer, which includes a container, a detecting unit, and a management unit. The container is used for accommodating an imaging material, where the imaging material is a powdery material or a liquid material. The detecting unit is disposed on a surface of the container. The management unit is coupled to the detecting unit. The detecting unit detects a capacitance value to determine a remaining capacity of the container, and when the remaining capacity is lower or higher than a threshold, the detecting unit transmits a trigger signal to the management unit. When the management unit receives the trigger signal, the management unit generates a notification.

In view of the above, the present invention provides a detecting device and a printer including the detecting device, which can determine a remaining capacity in a container (for example, a toner cartridge or an ink cartridge) by using a detected capacitance value, and generate a corresponding notification according to different usage requirements.

In order to make the aforementioned and other objectives and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a detecting device according to an embodiment of the present invention.

FIG. 2 is a schematic sectional view of a detecting device according to an embodiment of the present invention.

FIG. 3 is a function block diagram of a printer according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

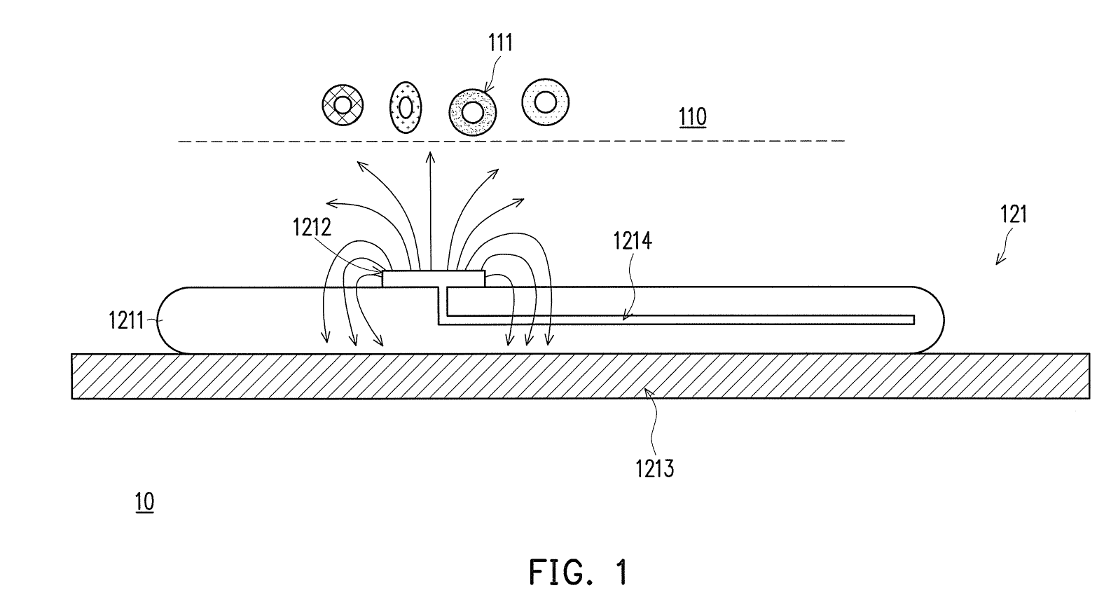

FIG. 1 is a schematic structural view of a detecting device according to an embodiment of the present invention. Referring to FIG. 1, a detecting device 10 is adapted to be disposed in a printer, and includes a container 110 and a detecting unit. The container 110 is used for accommodating an imaging material 111, where the imaging material is a powdery material or a liquid material. The powdery material is, for example, toner, and the container 110 is a toner cartridge or a waste toner cartridge. The liquid material is, for example, ink, and the container 110 is an ink cartridge. In this embodiment, illustration is made by taking the imaging material 111 being the toner as an example.

The detecting unit is disposed on an outer surface of the container 110, and detects a capacitance value to determine a remaining capacity of the container 110. When the remaining capacity is lower or higher than a threshold, the detecting unit transmits a trigger signal to a management unit of the printer to generate a notification.

In this embodiment, the detecting unit 120 includes a sensor 121 and a sensing processing unit. Also, in the embodiment shown in FIG. 1, a structure and an actuation mode of the sensor are illustrated, so the sensing processing unit is omitted in FIG. 1.

The sensor 121 includes a carrier 1211, a sensor pad 1212, and a physical signal reference level surface 1213. A surface (that is, dotted lines shown in FIG. 1) of the carrier 1211 parallel to the container 110 may be a planar plate such as a substrate or flexible plate. The sensor pad 1212 is disposed on a first surface of the carrier 1211, and is parallel to the carrier 1211. The sensor pad 1212 is coupled to the sensing processing unit through a lead 1214, after a charging process of the sensing processing unit, generates a detection capacitance value through a capacitance coupling effect, and transmits the detection capacitance value to the sensing processing unit. The physical signal reference level surface 1213 is disposed on a second surface of the carrier, that is, another surface opposite to the surface where the sensor pad 1212 is disposed. Moreover, the physical signal reference level surface 1213 is also coupled to the sensing processing unit. In this embodiment, the reference level is a ground plane.

The sensing processing unit respectively receives the detection capacitance value from the sensor pad 121, and receive a reference capacitance value corresponding to the detection capacitance value from the physical signal reference level surface 1213. The sensing processing unit generates a capacitance value by using a comparison result of the detection capacitance value and the reference capacitance value.

It should be noted that, the reference capacitance value, in addition to being received from the physical signal reference level surface 1213, may also be obtained from an external power supply, or a coupling capacitor (not shown) coupled to the sensing processing unit. The obtaining mode of the reference capacitance value is not limited in the present invention.

The detection capacitance value changes along with the environment around the sensor pad 1212 and the physical signal reference level surface 1213, so the capacitance value generated by the sensing processing unit is also affected. For example, when the amount of the imaging material 111 in the container 110, that is the toner, increases, the detection capacitance value generated by the sensor pad 1212 changes according to the change of the amount of the imaging material. Therefore, the capacitance value generated by the sensing processing unit also changes along with the change of the amount of the imaging material 111 in the container 110. For example, when the imaging material 111 increases, the capacitance value decreases accordingly, but the change trend may change along with the property of the imaging material 111, which is not limited in the present invention.

A major factor of the change of the surrounding environment lies in the change of the amount of the imaging material 111 in the container 110, so the sensing processing unit can calculate to obtain the remaining capacity of the container 110 according to the capacitance value. When the remaining capacity is lower or higher than a threshold, the sensing processing unit transmits a trigger signal or value to a management unit of the printer to generate a notification. For example, when the container 110 is a waste toner cartridge, if the remaining capacity is lower than the threshold, the sensing processing unit transmits the trigger signal to the management unit of the printer. When the container 110 is a toner cartridge, if the remaining capacity is higher than the threshold, the sensing processing unit transmits the trigger signal to the management unit of the printer. A correspondence of the magnitude of the threshold and the capacitance value with the remaining capacity is determined according to actual implementations, and is not limited in the present invention.

In fact, operation principles of the sensor and the sensing processing unit in this embodiment are similar to an operation principle of a touching pad disposed in an electronic device such as a notebook computer. Therefore, the sensor and the sensing processing unit may be disposed in a mode referring to disposition modes of a sensor and a sensing processing unit in the touching pad, and are implemented by performing adjustment according to actual implementations. However, the present invention is not limited thereto.

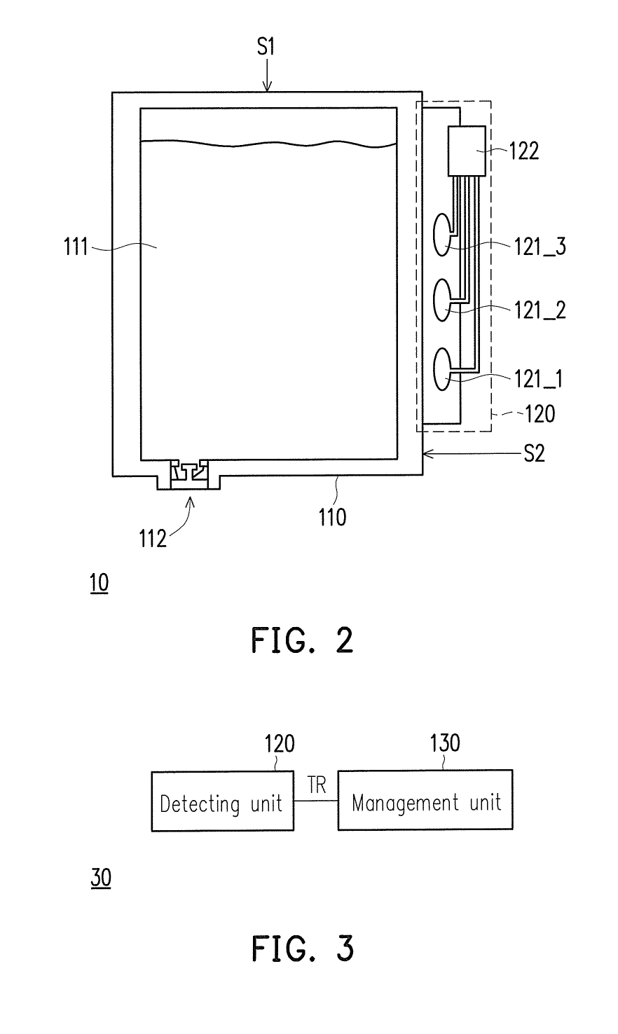

FIG. 2 is a schematic sectional view of a detecting device according to an embodiment of the present invention. Referring to FIG. 2, the detecting device 10 includes a container 110 and a detecting unit 120. The container 110 accommodates an imaging material 111, and includes an opening 112. In this embodiment, the detecting unit 120 is disposed on a surface S2 of the container 110, where the surface S2 is adjacent to the opening 112, or is adjacent to a surface provided with the opening 112. In addition, in another embodiment of the present invention, the detecting unit 120 may also be disposed on a surface S1 opposite to the opening 112. Moreover, the detecting device 10 may further be disposed on an inner surface of the container 110, and a position of disposing the detecting unit 120 is not limited in the present invention.

In this embodiment, the detecting unit 120 includes three sensors 121_1˜121_3, and a sensing processing unit 122, the sensors respectively detect the surrounding environment to generate a detection capacitance value, and transmit the detection capacitance value to the sensing processing unit 122. The sensing processing unit 122 generates 3 capacitance values through the 3 detection capacitance values, and then determines a current remaining capacity of the container 110 according to the capacitance values. Because the sensors 121_1˜121_3 are disposed on different positions on the surface S2, the remaining capacity determined by synthesizing the three capacitance values is more accurate and convenient than a remaining capacity determined according to only one capacitance value.

For example, the detection capacitance value and reference capacitance value of one of the sensors (for example, the sensor 121_1) may be used to detect the capacity of a medium, that is the imaging material, in an empty container, and the other two sensors (for example, the sensors 121_2 and 121_3) may be disposed at positions of a proper proportion on the container 110 so that the obtained 2 capacitance values generated according to the detection capacitance values and reference capacitance values are respectively corresponding to generation of a forecast notification (the remaining capacity is insufficient), or a full load notification (the container has no remaining capacity). Alternatively, two sensors correspondingly used for generating the full load notification are additionally disposed at two opposite sides of the container, so as to improve the reliability of the notification.

However, in this embodiment, because the positions of the sensors 121_{—} 1˜121_3 are successive, carriers and physical reference level surfaces of the sensors 121_1˜121_3 are connected to each other. When the positions of the sensors_{—} 121_1˜121_3 are not successive, the carriers and physical signal reference level surfaces of the sensors 121_1˜121_3 are disposed separately.

In another embodiment of the present invention, at least one capacitive sensor is disposed on a surface S2, at least one capacitive sensor is disposed on a surface S1, a plurality of capacitance values are generated through detection capacitance values retuned by the sensors, and a remaining capacity of the container 110 is then determined according to the capacitance values. In other words, the number and disposition position of the sensor are not limited the present invention, and the number and disposition position of the sensor may be adjusted according to situations of actual implementations.

The present invention further provides a printer. FIG. 3 is a function block diagram of a printer according to an embodiment of the present invention. Referring to FIG. 3, a printer 30 includes a container (not shown), a detecting unit 120, and a management unit 130. The container is used for accommodating an imaging material, where the imaging material is a powdery material or a liquid material. The detecting unit 120 is disposed on a surface of the container. The management unit 130 is coupled to the detecting unit 120. The detecting unit 120 detects a capacitance value to determine a remaining capacity of the container, and when the remaining capacity is lower or higher than a threshold, the detecting unit 120 transmits a trigger signal TR to the management unit. When the management unit 130 receives the trigger signal TR, the management unit generates a notification.

The notification is used to notify a user of the printer that the remaining capacity of the current container has been in a state requiring adjustment by the user. For example, when the container is a toner cartridge or an ink cartridge, and the detecting unit 120 determines that a remaining capacity of the container is higher than a threshold, the management unit 130 generates a notification to notify the user to replace the toner cartridge or ink cartridge. Moreover, when the container is a waste toner cartridge, and the detecting unit 120 determines that a remaining capacity of the container is lower than a threshold, the management unit 130 generates a notification to notify the user to empty the waste toner cartridge. The notification includes displaying a corresponding figure or a flashing light on an operation interface of the printer. In an embodiment of the present invention, when generating the notification, the management unit 130 also transmits a control signal to suspend the current printing work. A form and mode of the notification are not limited in the present invention.

It should be noted that, the printer 30 may include a plurality of containers, such as, toner cartridges and waste toner cartridges for accommodating different colors. In this implementation, the printer 30 also includes a plurality of detecting units (for example, detecting units 120) that are disposed on surfaces of the plurality of containers, for respectively detecting remaining capacities of the containers. The implementation of the detecting unit 120 may be obtained with reference to the embodiments shown in FIG. 1 and FIG. 2, and is not repeated herein.

In view of the above, the present invention provides a detecting device and a printer using the detecting device, so as to detect one or more capacitance values to determine the remaining capacity in the container, thereby notifying the user in an extreme situation, for example, when the remaining capacity of the toner cartridge is excessively high, or the remaining capacity of the waste toner cartridge is excessively low. Because the detecting unit in the detecting device is disposed on the surface of the container in a non-contact mode (not in contact with the detected imaging material), the influence of the imaging material on the detecting unit may be avoided from causing an inaccurate detection, for example, problems such as a detection point being covered by the toner and being incapable of work normally or a detection point being aged or corroded due to long-time immersion in the ink may be avoided. The disposition mode of the detecting unit is also convenient for the disposition and use of the container, for example, when replacing an ink cartridge or a toner cartridge, it is unnecessary to additionally set or adjust the detecting unit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A printer, comprising:
a container, for accommodating an imaging material, wherein the imaging material is a powdery material or a liquid material;
a detecting unit, disposed on a surface of the container; and
a management unit, coupled to the detecting unit,
wherein, the detecting unit detects a capacitance value to determine a remaining capacity of the container, when the remaining capacity is lower or higher than a threshold, the detecting unit transmits a trigger signal to the management unit; and
when the management unit receives the trigger signal, the management unit generates a notification.

2. The printer according to claim 1, wherein the detecting unit comprises:
a sensing processing unit;
a sensor, coupled to the sensing processing unit and disposed on an outer surface of the container, the sensor, after a charging process of the sensing processing unit, detecting the imaging material to obtain a detection capacitance value,
wherein the sensing processing unit obtains the detection capacitance value from the sensor, the sensing processing unit further generates the capacitance value according to a comparison result of the detection capacitance value and a reference capacitance value, and determines the remaining capacity of the container according to the capacitance value.

3. The printer according to claim 2, wherein the sensor comprises:
a carrier, parallel to the surface of the container;
a sensor pad, disposed on a first surface of the carrier and parallel to the carrier, coupled to the sensing processing unit, for generating the detection capacitance value through a capacitance coupling effect, and transmitting the detection capacitance value to the sensing processing unit; and
a physical signal reference level surface, disposed on a second surface of the carrier, and coupled to the sensing processing unit.

4. The printer according to claim 1, wherein:
the imaging material is toner; and
the container is a toner cartridge or a waste toner cartridge.

5. The printer according to claim 1, wherein:
the imaging material is ink; and
the container is an ink cartridge.

6. The printer according to claim 1, wherein:
the container comprises an opening; and
the detecting unit is disposed on a surface of the container, wherein the surface is opposite to the opening.

7. The printer according to claim 1, wherein:
the container comprises an opening; and
the detecting unit is disposed on a surface of the container, wherein the surface is adjacent to the opening.

8. The printer according to claim 1, wherein the detecting unit comprises:
a plurality of sensors, disposed on the container, for respectively detecting the imaging material in the container to obtain a plurality of detection capacitance values; and
a sensing processing unit, coupled to the sensors, for receiving the detection capacitance values respectively from the sensors, generating a plurality of capacitance values according to a plurality of comparison results of the detection capacitance values and a reference capacitance, and determining the remaining capacity according to the capacitance values.

9. The printer according to claim 8, wherein:
the container comprises an opening; and
at least one sensor of the sensors is disposed on a first surface of the container, and/or at least one sensor of the sensors is disposed on a second surface of the container, wherein the first surface is opposite to the opening, and the second surface is adjacent to the opening.

10. An imaging material detecting device, adapted to be disposed in a printer, comprising:
a container, for accommodating an imaging material, wherein the imaging material is a powdery material or a liquid material;
a detecting unit, disposed on a surface of the container,
wherein, the detecting unit detects a capacitance value to determine a remaining capacity of the container, and when the remaining capacity is lower or higher than a threshold, the detecting unit transmits a trigger signal to a management unit of the printer to generate a notification.

11. The device according to claim 10, wherein the detecting unit comprises:
a sensing processing unit;
a sensor, coupled to the sensing processing unit and disposed on an outer surface of the container, the sensor, after a charging process of the sensing processing unit, detecting the imaging material to obtain a detection capacitance value,
wherein the sensing processing unit obtains the detection capacitance value from the sensor, the sensing processing unit further generates the capacitance value according to a comparison result of the detection capacitance value and a reference capacitance value, and determines the remaining capacity of the container according to the capacitance value.

12. The device according to claim 11, wherein the sensor comprises:
a carrier, parallel to the surface of the container;
a sensor pad, disposed on a first surface of the carrier and parallel to the carrier, coupled to the sensing processing unit, for generating the detection capacitance value through a capacitance coupling effect, and transmitting the detection capacitance value to the sensing processing unit; and
a physical signal reference level surface, disposed on a second surface of the carrier, and coupled to the sensing processing unit.

13. The device according to claim 10, wherein:
the imaging material is toner; and
the container is a toner cartridge or a waste toner cartridge.

14. The device according to claim 10, wherein:
the imaging material is ink; and
the container is an ink cartridge.

15. The device according to claim 10, wherein:
the container comprises an opening; and
the detecting unit is disposed on a surface of the container, wherein the surface is opposite to the opening.

16. The device according to claim 10, wherein:
the container comprises an opening; and
the detecting unit is disposed on a surface of the container, wherein the surface is adjacent to the opening.

17. The device according to claim 10, wherein the detecting unit comprises:
a plurality of capacitive sensors, disposed on the container, for respectively detecting the imaging material in the container to obtain a plurality of detection capacitance values; and
a sensing processing unit, coupled to the sensors, for receiving the detection capacitance values respectively from the sensors, generating a plurality of capacitance values according to a plurality of comparison results of the detection capacitance values and a reference capacitance value, and determining the remaining capacity according to the capacitance values.

18. The device according to claim 17, wherein:
the container comprises an opening; and
at least one sensor of the sensors is disposed on a first surface of the container, and/or at least one sensor of the sensors is disposed on a second surface of the container, wherein the first surface is opposite to the opening, and the second surface is adjacent to the opening.
